(19) United States
(12) Patent Application Publication
(10) Pub. No.: US 2013/0181880 A1
(43) Pub. Date: Jul. 18, 2013

(54) LOW PROFILE WIDEBAND MULTIBEAM INTEGRATED DUAL POLARIZATION ANTENNA ARRAY WITH COMPENSATED MUTUAL COUPLING

(71) Applicants: Lin-Ping SHEN, Ottawa (CA); Hafedh TRIGUI, Ottawa (CA); Stuart James DEAN, Kemptville (CA); Bing YAN, Ottawa (CA)

(72) Inventors: Lin-Ping SHEN, Ottawa (CA); Hafedh TRIGUI, Ottawa (CA); Stuart James DEAN, Kemptville (CA); Bing YAN, Ottawa (CA)

(21) Appl. No.: 13/351,574

(22) Filed: Jan. 17, 2012

(51) Int. Cl. H01Q 21/00; G06F 17/50

(52) U.S. Cl. 343/853; 716/132

(57) ABSTRACT

A low profile wideband multi-beam integrated dual polarization antenna array with compensated mutual coupling effect. Instead of suppressing mutual coupling with post-element-design techniques by attempting to block the reflections between elements, an element of the array is designed using its active impedance, i.e. its impedance with mutual coupling once the element is part of the array. The active impedance is determined using various simulation techniques and the element is then designed such that its impedance is shifted in order to modify its active impedance. This technique does not reduce the mutual coupling itself but instead, compensates for the mutual coupling effect and improves the return loss of the element.

### CROSS-REFERENCE TO RELATED APPLICATIONS

This is the first application filed for the present invention.

### TECHNICAL FIELD

The present invention relates to the field of wireless communication systems and antenna arrays suitable for both transmission and reception of electromagnetic radiation.

### BACKGROUND OF THE ART

Certain designs for antenna arrays consist of closely spaced wideband antenna elements. In order to maintain a small overall size and required antenna performances, such as a wide beam width and a high cross-over point between three individual beams, the spacing between the antenna elements is kept to a minimum (i.e, less than or equal to half a wavelength of a center frequency point). However, the close proximity of the antenna elements causes significant mutual coupling effects, thereby affecting the overall performance of the antenna array.

It is well-known to reduce mutual coupling effects by putting isolators, such as electromagnetic bandgaps (EBGs), between element patches, or to add some slots to the element grounding plane. For applications requiring small spacing between the elements, these techniques do not work well. This is particularly the case for low profile wideband multi-beam integrated dual polarization antenna arrays.

Therefore, there is a need to provide an alternative method of reducing mutual coupling effects for antenna arrays requiring closely spaced wideband antenna elements.

### SUMMARY

There is described herein a low profile wideband multi-beam integrated dual polarization antenna array with compensated mutual coupling effect. Instead of suppressing mutual coupling with post-element-design techniques by attempting to block the reflections between elements, an element of the array is designed using its active impedance, i.e. its impedance with mutual coupling once the element is part of the array. The active impedance is determined using various simulation techniques and the element is then designed such that its impedance is shifted in order to modify its active impedance. This technique does not reduce the mutual coupling itself but instead, compensates for the mutual coupling effect and improves the return loss of the element.

In accordance with a first broad aspect, there is provided a method for designing an antenna element for an array of antenna elements, the method comprising: identifying a desired impedance for the antenna element within a required frequency band; determining an active impedance based on the desired impedance of the antenna element and mutual coupling with neighboring elements of the array; selecting an optimal impedance for the antenna element to cause the active impedance to substantially correspond to the desired impedance; and designing the antenna element with the optimal impedance, whereby the optimal impedance does not correspond to the desired impedance but the active impedance based on the optimal impedance does.

In accordance with another broad aspect, there is provided a wideband multi-beam integrated dual polarization antenna array for at least one of transmission and reception of electromagnetic radiation, the array comprising: at least two wideband beam forming networks each having at least three inputs; at least four wideband sub-arrays of antenna elements connected between the at least two wideband beam forming networks; and at least two antenna elements in each of the sub-arrays of antenna elements, each of the at least two antenna elements having an actual impedance, and at least one of the at least two antenna elements having an active impedance that corresponds to a desired impedance for the at least one antenna element individually while the actual impedance does not.

### BRIEF DESCRIPTION OF THE DRAWINGS

Further features and advantages of the present invention will become apparent from the following detailed description, taken in combination with the appended drawings, in which:

FIG. 1a is an example of a planar array (4×4 array) with azimuth (AZ) beam forming networks (BFN) located between the rows of elements and an elevation (EL) BFN;

FIG. 1b is an example of planar array (4×4 array) with EL BFNs located between the columns of elements and an AZ BFN;

FIG. 2 is an exemplary wideband multibeam integrated dual polarization antenna array;

FIG. 3a is an exemplary wideband 1×2 sub-array from FIG. 2;

FIG. 3b is an exemplary layout schematic of the wideband 1×2 sub-array;

FIG. 4a is an exemplary 3×4 Butler matrix from FIG. 2;

FIG. 4b is an exemplary layout schematic of the 3×4 Butler matrix;

FIG. 5 is a cross-sectional view of an exemplary layout of a low profile wideband multibeam integrated dual polarization antenna array;

FIG. 6 is an exemplary layout schematic of the low profile wideband multibeam integrated dual polarization antenna array;

FIG. 7a is a schematic illustration of two antenna elements and their corresponding signals;

FIG. 7b is a Smith Chart showing S₁₁ of the antenna element before/after tuning;

FIG. 7c is a Smith Chart showing S_{active} of the antenna element before/after tuning;

FIG. 8 is a graph of the measured return loss of the central beam port (B+45) of the C band 2×4 array; and

FIG. 9 illustrates an exemplary embodiment for a support.

It will be noted that throughout the appended drawings, like features are identified by like reference numerals.

### DETAILED DESCRIPTION

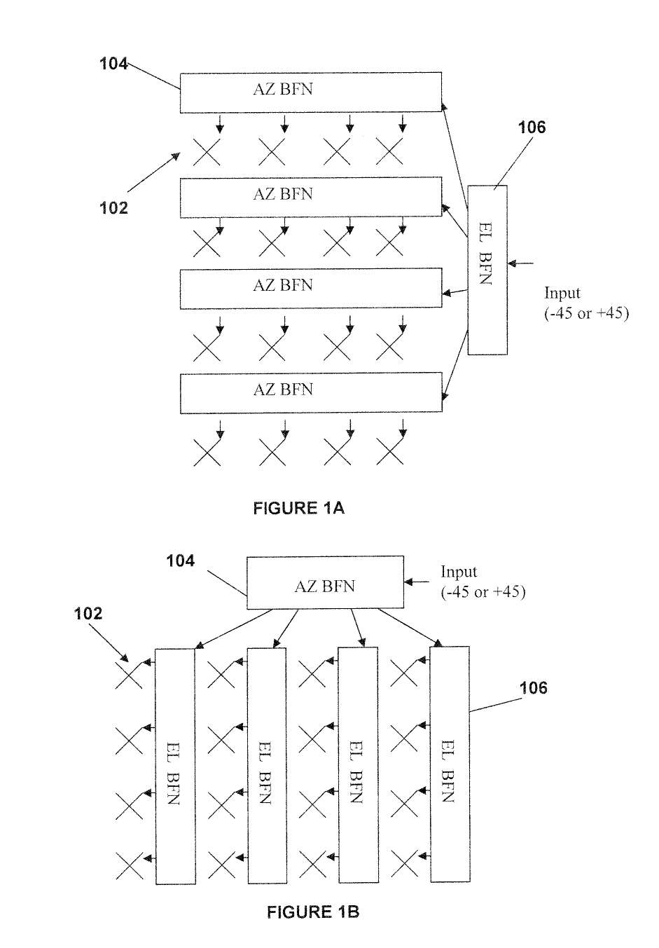

FIGS. 1A and 1B are example architectures of a planar array with M rows and N columns consisting of three main parts: the antenna elements 102, azimuth beam forming networks (AZ BFN) 104, and an elevation beam forming network (EL BFN) 106. There are two basic structures as shown. FIG. 1A is an example of the planar array (M=4 Rows and N=4 columns) with AZ BFN 104 located between the antenna elements and EL BFN 106, and FIG. 1B is an example of the planar array (M=4 Row and N=4 column) with EL BFN 106 located between the antenna elements and AZ BFN 104. For some arrays with simple functions such as single beam or fixed tilted arrays, the BFN may be as simple as a T-splitter network. For other arrays with more complex functions such as multibeam or variable tilted arrays, the BFN may be a Butler Matrix or a phase shifter. The corresponding architecture is determined based on the functions of the required planar array. In some embodiments, FIG. 1A is used for a variable-tilted array and FIG. 1B is used for a fixed-tilted array.

For dual polarization three-beam arrays (total six beams: L+45, B+45, R+45; L−45, B−45, and R−45), a 2×4 planar array (M=2 and N=4) meets the basic beam requirements such as gain and beam width. In the case of a fixed-tilted multibeam array, the AZ BFN 104 is much more complex than the EL BFN 106. Therefore, because the number M (=2) of rows of the array is less than the number N (=4) of columns of the array, in order to reduce the number of AZ BFN 104, FIG. 1B may be used for a C-band multibeam array, where only two AZ BFN are required.

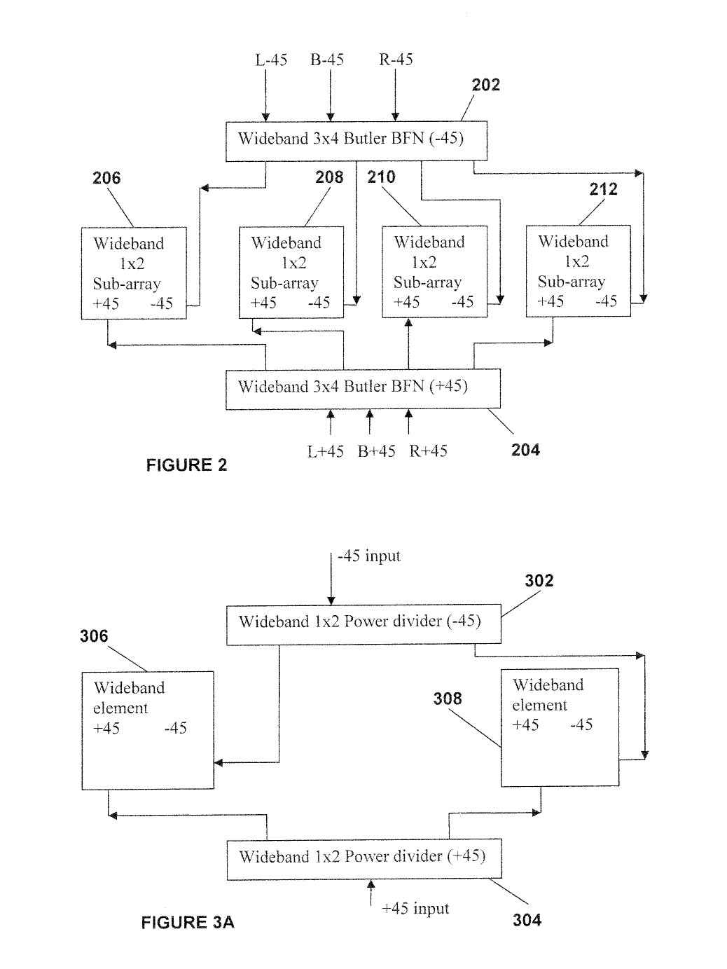

FIG. 2 is an exemplary block diagram of a wideband multibeam integrated dual polarization array antenna (M=2 and N=4). Two wideband 3×4 Butler BFN 202, 204 are provided in order to achieve the dual polarization and multibeam features. In the illustrated case of a Butler BFN, the inputs are isolated from each other and the phases of the outputs are linear with respect to position of the antenna element, so the left and right beams are tilted off the main axis. A set of wideband 1×2 sub-arrays 206, 208, 210, 212 are connected between the BFNs 202, 204.

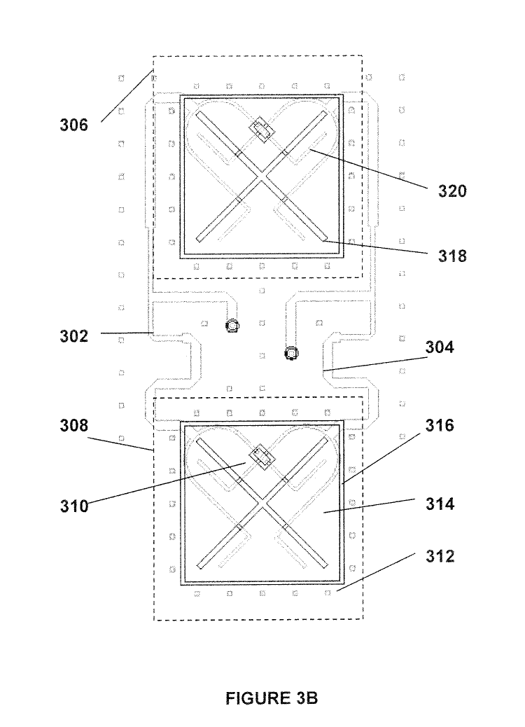

An exemplary embodiment for one of the wideband 1×2 sub-arrays 206, 208, 210, 212 is illustrated in FIGS. 3a and 3b. As per the block diagram of FIG. 3a, a pair of wideband 1×2 T-splitter power dividers 302, 304 are connected between a pair of wideband elements 306, 308. FIG. 3b illustrates an exemplary layout schematic (top-view) for the wideband dual polarization 1×2 sub-array 206, in which dual polarization slot coupled patch elements 306, 308 are used for easy integration. Due to the multilayer nature, vias 310 and 312 are used between different layers for cross-over, and a metal cavity is used for a reduced surface wave coupling. For the slot-coupled patch elements 306, 308, two stack patches 314 and 316 are used for wideband operation. A slot 318 is used in a ground layer and a feeder stub 320 is used in a signal feeder layer. The size/position of the cavity vias 310, 312 are used for adjusting the impedance characteristics of the elements 306, 308.

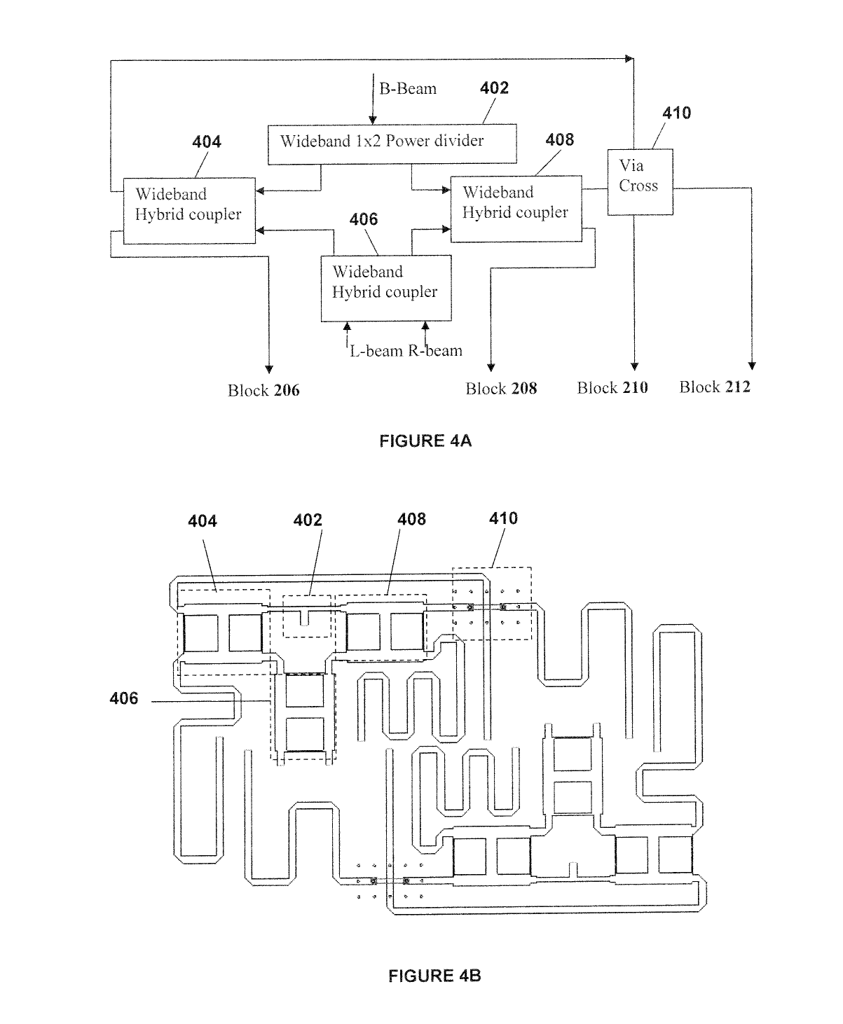

FIGS. 4a and 4b illustrate an exemplary embodiment of one of the wideband 3×4 Butler BFNs 202, 204 from FIG. 2. As per the block diagram of FIG. 4a, a wideband 1×2 T-splitter power divider 402 receives the broadside beam (B-Beam) and divides the power into two wideband hybrid couplers 404, 408. A third wideband hybrid coupler 406 receives the left-side beam and the right-side beam directly and feeds into wideband hybrid couplers 404 and 408. Wideband hybrid coupler 404 will feed into wideband 1×2 sub-array 206 directly and into wideband 1×2 sub-arrays 210 and 212 through via cross 410. Wideband hybrid coupler 408 will feed into wideband 1×2 sub-array 208 directly and into wideband 1×2 sub-arrays 210 and 212 through via cross 410. FIG. 4b illustrates an exemplary layout schematic for two wideband 3×4 Butler BFNs in a signal layer. In order to achieve the same beam pattern property for two polarizations (+45 and −45), two 3×4 Butler BFNs are identical and rotationally symmetrical.

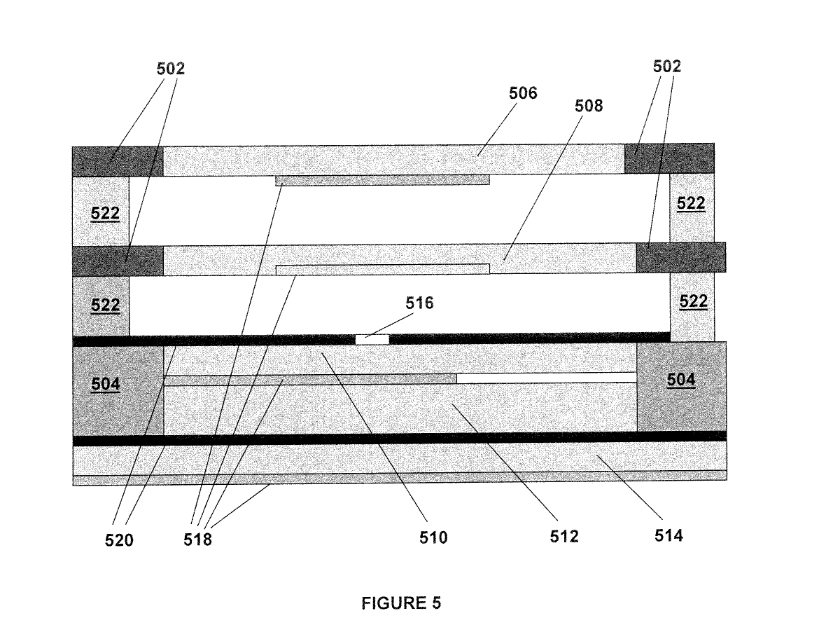

FIG. 5 is a cross-sectional view of an exemplary layout for the wideband multibeam integrated dual polarization antenna array. Five layers of Printed Circuit Board (PCB) are provided to account for a BFN layer 514, a feed line layer 512, a slot layer 510 (and slot 516), and two element layers 506, 508. In one embodiment, the BFN layer 514 is composed of a six-layer PCB and both antenna element layers 506 and 508 are composed of double-layer PCBs. The two wideband 3×4 BFN 202, 204 may be realized on a single plane.

An EBG 502 is provided at the end of each element layer 506, 508. Another EBG 504 is provided at the end of the slot layer 510 and feed layer 512 for isolation between ground planes 502. Any known EBG type, such as UCEBG (Uniplanar Compact EBG), SRR (Split Ring Resonator), and slot on the ground plane, may be used for the reduction of the mutual coupling between the elements.

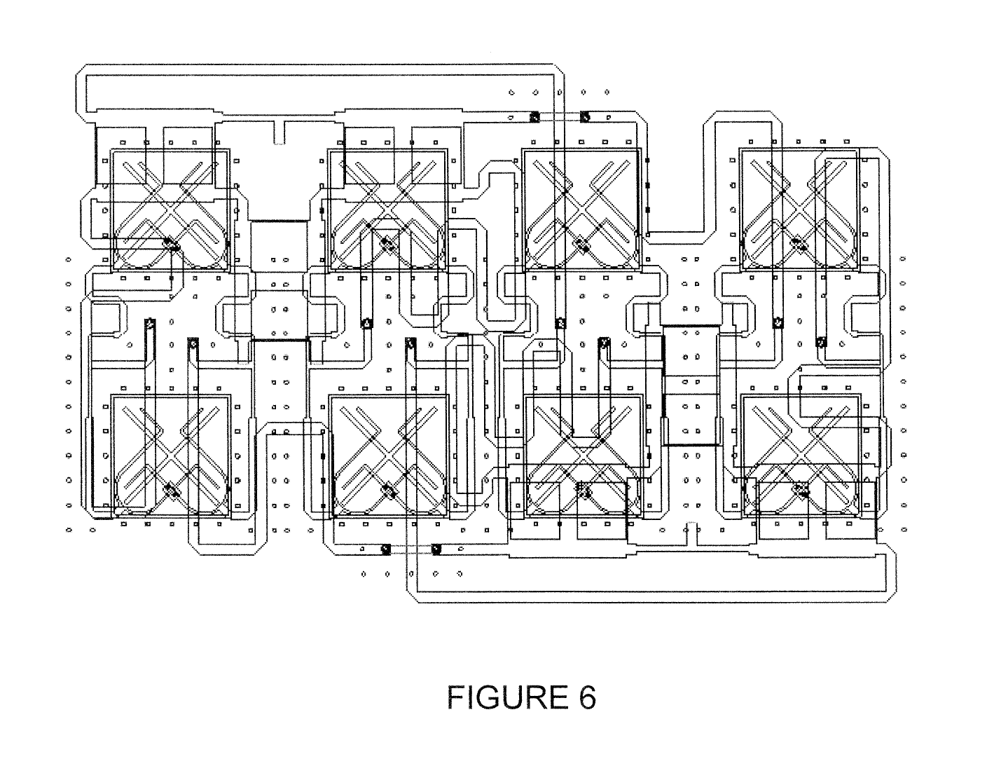

Vias (not shown) are provided between the feed layer 512 and the slot layer 510, between the feed layer 512 and the BFN layer 514, and between the two ground planes 520. Patch/tracks 518 are also inserted between the layers where appropriate. Supports 522 are used between the two element layers 506 and 508, and between element layer 508 and slot layer 510. The supports 522 may be made of plastic or other alternative materials. FIG. 6 is a layout schematic of an exemplary embodiment for the wideband multibeam integrated dual polarization antenna array, including the partial schematics shown in FIGS. 3b and 4b.

The mutual coupling improvement obtained by putting EBG 502 and 504 between elements is very limited due to the narrow spacing of the array. In turn, it will degrade the return loss performance of the array, especially for the broadside beam (B+45 and B−45) ports. In order to improve the array performance, certain techniques to compensate the mutual coupling are used.

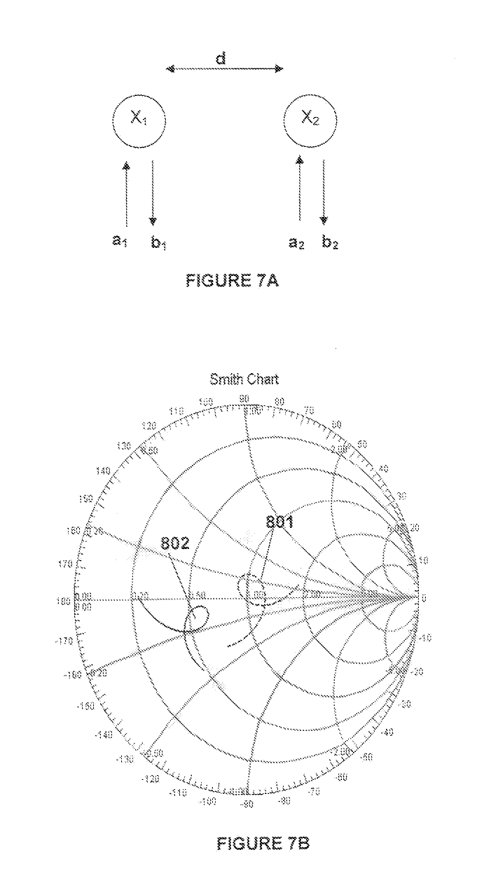

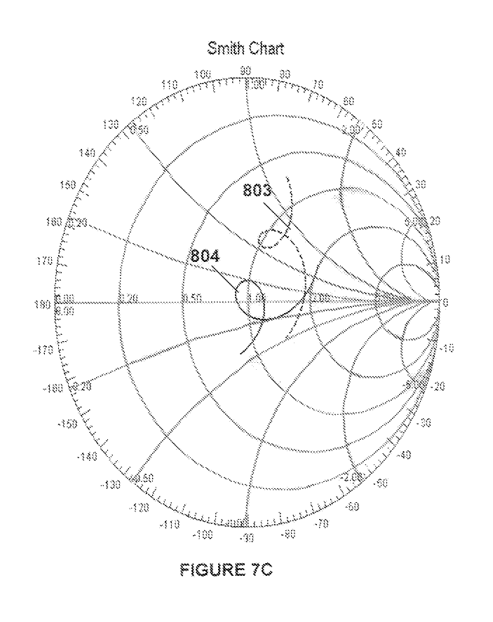

FIG. 7A is a schematic illustration of two antenna array elements, element x₁ and element x₂. Signals a₁ and a₂ are incoming signals for elements x₁ and x₂, respectively. Signals b₁ and b₂ are reflected signals for elements x₁ and x₂, respectively. Elements x₁ and x₂ are separated by a distance d. The reflected signals b₁ and b₂ may be represented by the following scattering parameter (or S-parameter) equations:

b₁=S₁₁a₁+S₁₂a₂

−b₂=S₂₁a₁+S₂₂a₂

where S₁₁ is the voltage reflection coefficient (or return loss in dB) of element x₁ (or the reflection from element x₁ by assuming a₂ equal to zero), S₂₂ is the voltage reflection coefficient (or return loss in dB) of element x₂ (or the reflection from element x₂ by assuming a₁ equal to zero), and S₂₁ and S₁₂ represent the mutual coupling between the element x₁ and the element x₂. The active impedance S_{active} of an element may be defined as the total reflection felt at the element and may be represented (for element x₁) as follows:

$${S}_{active} = \frac{{b}_{1}}{{a}_{1}} = {S}_{11} + {S}_{12} \frac{{a}_{2}}{{a}_{1}} ;$$

FIG. 7B is a schematic illustration of Sᵢᵢ of the antenna array element. The curve 801 is perfectly located at the center of the Smith chart and the element is designed to match the 50 ohm impedance within the required frequency band. FIG. 7C is a schematic illustration of S_{active} of the antenna array element. Due to the impact of the mutual coupling, the curve 803 is located off the center of the Smith chart and the element and array have degraded impedance and pattern performances. In order to compensate for the mutual coupling effect of neighboring elements in an array, Sᵢᵢ is shifted from its original value to a value that will provide a modified S_{active}. In other words, when the impedance performance of the antenna element is shifted from the initial curve 801 to 802, based on the above mentioned formula, the impedance of the element and array is improved from the curve 803 to the curve 804 located at the center of the Smith chart.

Some of the techniques used to shift S₁₁ comprise changing the element's impedance value as follows:

1. Adjusting the spacing between layers of the antenna element;
2. Adjusting the length and/or width of a feeder stub (312);
3. Changing the length and/or width of the slot (311); and
4. Changing the placement and/or spacing and/or size of the plated through hole (PTH) between two grounding planes (312).

Other techniques known to those skilled in the art may also be used. The mutual coupling compensation technique described herein allows the antenna elements and a beam forming network to be integrated into a multi-layer structure using conventional multi-layer PCB technology. Other techniques may also be used in combination with the mutual coupling compensation technique to further improve the performance of the low profile wideband multibeam integrated dual polarization antenna array.

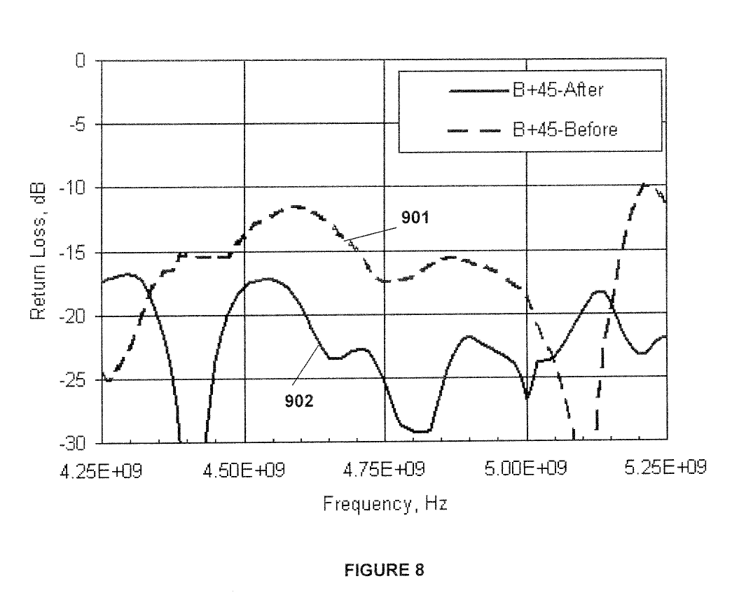

FIG. 8 is the measured return loss of the central beam port (B+45) of the C band 2×4 array. The curve 901 is the return loss of the 2×4 array (>12 dB) before the tuning and the curve 902 is the return loss of the 2×4 array (>17 dB) after the tuning of the element using the above-described techniques.

As per the above, one of the strategies used to shift the impedance of the element and thereby modify the active impedance of the element is to adjust the spacing between layers. Referring back to the embodiment illustrated in FIG. 5, the total thickness may be about 11 mm, or from about 9 mm to about 13 mm. Element layers 506 and 508 are both set to about 0.5 mm, and the supports 522 are each about 3.0 mm. The slot and feed layers 510 and 512 together with the patch/track 518 is about 0.8 mm. The PCB for the BFN 514 may have a thickness of about 0.8 mm while the EBGs 504 may be about 1.6 mm. When taking into account the additional space for the ground layers 520 and the patch/track 518, the total thickness may be between about 10.2 mm and about 11.0 mm. The measurements included herein may be increased or decreased by about +/−20%. The supports 522, the ground layers 520, and the EBGs 504 may all be made thicker or thinner in order to shift the impedance of the element.

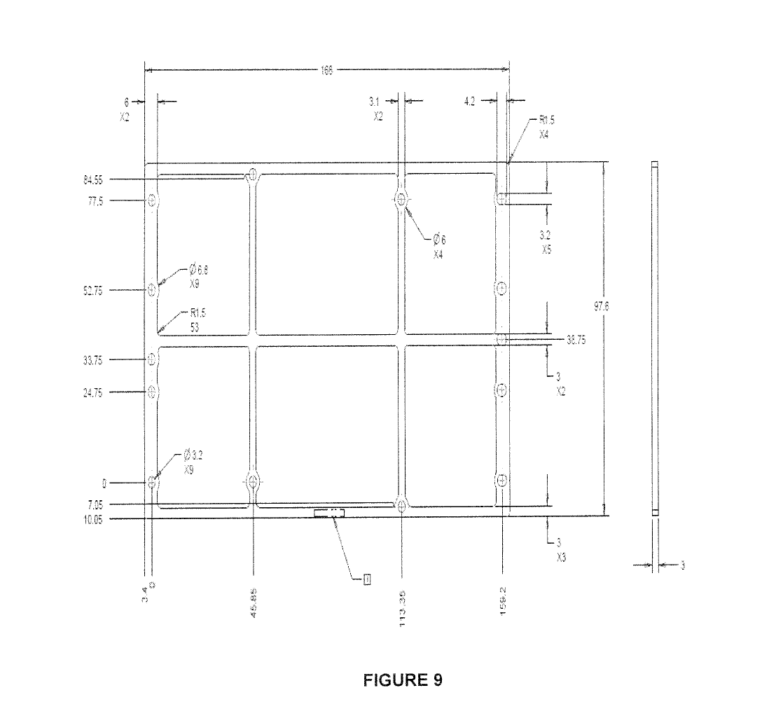

FIG. 9 is an illustration of an exemplary embodiment for the supports 522 that may be used to shift the impedance. The length and/or width of the feed layer 510 may be adjusted, thereby causing a shift in impedance and a modified active impedance. The length and/or width of the slot 516 may be adjusted, thereby causing a shift in impedance and a modified active impedance. Changing the placement and/or spacing and/or size of the plated through hole (PTH) between two grounding planes, as shown in FIG. 6, may also be used to shift the impedance.

The embodiments of the invention described above are intended to be exemplary only. The scope of the invention is therefore intended to be limited solely by the scope of the appended claims.

1. A method for designing an antenna element for an array of antenna elements, the method comprising:
identifying a desired impedance for the antenna element within a required frequency band;
determining an active impedance based on the desired impedance of the antenna element and mutual coupling with neighboring elements of the array;
selecting an optimal impedance for the antenna element to cause the active impedance to substantially correspond to the desired impedance; and
designing the antenna element with the optimal impedance, whereby the optimal impedance does not correspond to the desired impedance but the active impedance based on the optimal impedance does.

2. The method of claim 1, further comprising applying the method to a preliminary design of the antenna element having the desired impedance as its impedance, and wherein designing the antenna element with the optimal impedance comprises changing at least one parameter of the preliminary design of the antenna element to obtain the optimal impedance.

3. The method of claim 2, wherein changing at least one parameter comprises adjusting a spacing between layers of a multi-layer antenna element.

4. The method of claim 2, wherein changing at least one parameter comprises adjusting at least one of length and width of a feeder stub in the antenna element.

5. The method of claim 2, wherein changing at least one parameter comprises changing at least one of a length and a width of a slot of the antenna element.

6. The method of claim 2, wherein changing at least one parameter comprises changing at least one of placement, spacing and size of a plated through hole of two grounding planes in the antenna element.

7. The method of claim 1, further comprising designing the array of antenna elements as a low profile wideband multi-beam integrated dual polarization antenna array.

8. The method of claim 7, wherein the antenna array comprises five layers of printed circuit board comprising a beam forming network layer, a feed line layer, a slot layer, and two element layers.

9. The method of claim 8, wherein the antenna array comprises electromagnetic band gaps to reduce the mutual coupling.

10. A wideband multi-beam integrated dual polarization antenna array for at least one of transmission and reception of electromagnetic radiation, the array comprising:
at least two wideband beam forming networks each having at least three inputs;
at least four wideband sub-arrays of antenna elements connected between the at least two wideband beam forming networks; and
at least two antenna elements in each of the sub-arrays of antenna elements, each of the at least two antenna elements having an actual impedance, and at least one of the at least two antenna elements having an active impedance that corresponds to a desired impedance for the at least one antenna element individually while the actual impedance does not.

11. The antenna array of claim 10, wherein the at least two wideband beam forming networks and the at least four wideband sub-arrays of antenna elements are formed on five layers of printed circuit board comprising a beam forming network layer, a feed line layer, a slot layer, and two element layers.

12. The antenna array of claim 11, wherein the at least two wideband beam forming networks are realized on a single plane composed of the beam forming network layer.

13. The antenna array of claim 11, wherein the beam forming network layer is composed of a six-layer printed circuit board.

14. The antenna array of claim 11, wherein the two element layers are each composed of double-layer printed circuit boards.

15. The antenna array of claim 11, wherein the array has a total thickness of about 9 mm to about 13 mm.

16. The antenna array of claim 15, wherein the array has a total thickness of about 10.2 mm to about 11.0 mm.

17. The antenna array of claim 11, wherein the antenna array comprises electromagnetic band gaps to reduce mutual coupling between neighboring elements.

18. The antenna array of claim 10, wherein the at least two wideband beam forming networks are Butler Matrix beam forming networks.

19. The antenna array of claim 10, wherein the at least four wideband sub-arrays of antenna elements each comprise at least two wideband power dividers.

20. The antenna array of claim 10, wherein the at least two wideband beam forming networks comprise at least one wideband power divider and at least three wideband hybrid couplers.
